(19) United States
(12) Patent Application Publication
(10) Pub. No.: US 2007/0255693 A1
(43) Pub. Date: Nov. 1, 2007

(54) USER INTERFACE METHOD AND SYSTEM FOR INCREMENTALLY SEARCHING AND SELECTING CONTENT ITEMS AND FOR PRESENTING ADVERTISING IN RESPONSE TO SEARCH ACTIVITIES

(75) Inventors: Satyanarayanan Ramaswamy, Windham, NH (US); Gurudutt Pai, North Andover, MA (US)

Correspondence Address: WILMER CUTLER PICKERING HALE AND DORR LLP, 60 STATE STREET, BOSTON, MA, 02109, US

(73) Assignee: Veveo, Inc.

(21) Appl. No.: 11/694,596

(22) Filed: Mar. 30, 2007

Related U.S. Application Data
(60) Provisional application No. 60/787,412, filed on Mar. 30, 2006.

(51) Int. Cl. G06F 17/30

(52) U.S. Cl. 707/3

(57) ABSTRACT

A user-interface method of incrementally identifying and presenting a collection of content items and a collection of advertisements in which the identification is at least in part based on input incrementally entered by a user on an input-constrained device is presented. The method includes providing a set of content items and bids with associated advertisements. The bids organized into unambiguous and ambiguous categories. Incremental input is entered in order to identify desired content items. In response to the incremental input content items are identified and provided. Advertisements are also identified and provided based on a predetermined function. The presentation order is determined at least in part by an economic utility function.

### CROSS REFERENCE TO RELATED APPLICATIONS

This application claims benefit under 35 U.S.C. § 119(e) of U.S. Provisional Patent Application Ser. No. 60/787,412, filed Mar. 30, 2006, entitled Method And System For Advertising In Systems Supporting Incremental Search, which is herein incorporated by reference in its entirety.

### BACKGROUND OF THE INVENTION

1. Field of Invention

The invention generally relates to providing advertisements in systems utilizing incremental search and, more specifically, to selecting advertisements for display to the user even before the user has entered whole meaningful words in the language in which the text is entered.

2. Description of Related Art

Most of the commercially available search engines available today support intent-based advertisements, where the user intent is estimated based on the keywords the user has entered for searching. Examples of such search engines are Google and Yahoo!. In those systems, advertisers bid for keywords that are entered by users. When the user types in a keyword for searching, and there are advertisers who have bid for that keyword, the system selects the advertisements to be displayed and then displays the advertisements related to the entered keyword along with the results of the search. A key aspect of such prior systems is that search results are generated based on the user entering complete keyword(s) and then explicitly instructing the search engine (through mechanisms such as the “Search” button) to perform a search based on the entered keyword(s). Such systems return results only after the user has instructed the search engine to perform the search and do not return search results for every character entered as and when the characters are entered.

A new development in search engine technology is the incremental search with minimal text entry. There could be several reasons incremental search with minimal text entry is required. One reason could be that the devices using incremental search are input-constrained. For example, mobile phones and TV remotes that have limited text entry capabilities are good candidates to use incremental search. Incremental search with minimal text entry could also be used in normal computers with dedicated keyboards, the objective being to reduce the time and effort required to obtain the required results, this benefit deriving out of minimal text entry.

In systems incorporating incremental search with minimal text entry, search results are returned as text is entered. With every incremental character entered, or removed, a new search is conducted using the search string entered. Depending on the efficiency of the search algorithm, the results expected by the user are displayed even before a full word of text is entered. Therefore, the user need not enter all the characters in the keyword he has in mind in order to obtain the results corresponding to the keyword. The user enters only as many characters as are required to obtain the result desired to appear and then selects the desired result. For example, in order to obtain the results for “pizza”, the user is not required to first enter the entire word “pizza” and then request a search. As soon as the user enters “p” results from that search are returned. Once the user enters the character “i” a new search is conducted and the result set is narrowed. If the user sees the results for “pizza” among the set returned after entering “pi”, he selects the result immediately without entering any more characters.

The data space on which the search is performed can be either from a single domain (for example, only entertainment content) or from multiple domains (for example, entertainment content, phone directories, stock quotes, etc). There are many variations of the minimal text entry methodology depending on the specialized data domains in which the search is performed. For example, in data domains that require entry of names of people, the initials of the person concerned could be a valid search. Partial prefixes of the components of the names of persons or titles of movies or books could be also used.

Advertisement systems and methods based on full keyword entry function only after the complete word is entered. The key problem in using advertisement systems and methods based on full keyword entry in search systems based on incremental search is that in systems using incremental search, the user would likely choose a search result well before entering a full word. Therefore, advertisement opportunities would be lost if the system waits for the user to enter a full word before displaying advertisements.

Hence, there is a need for an advertisement system and method that will work in search systems based on incremental search using minimal text entry, such that even when the user has not entered a full word, suitable advertisements can be displayed to the user.

### BRIEF SUMMARY OF THE INVENTION

The invention provides user interface methods and systems for incrementally searching and selecting content items and for presenting advertising in response to search activities.

In accordance with one embodiment of the invention, a user-interface method of incrementally identifying and presenting a collection of content items and a collection of advertisements in which the identification is at least in part based on input incrementally entered by a user on an input-constrained device is presented. The method includes providing a set of content items where each content item has at least one associated descriptive term that describes the content item. The method also includes providing a set of bids and associated advertisements where a bid comprises at least one descriptive term that describes an associated advertisement and where the bids are organized into at least an unambiguous category and an ambiguous category. Incremental input is entered on an input-constrained device by the user in order to identify desired content items. The input having a set of user entry actions, each entry action having an associated set of at least one alphanumeric symbols that is indicative of at least one prefix for a descriptive term the user is using to identify desired content.

In response to the incremental input entered by the user, a relevant subset of the content items is identified and provided to the user. In addition, each bid in the unambiguous category is checked and it is determined whether the incremental input matches a descriptive term describing an associated advertisement. If at least one match is detected then the associated advertisements for all matching bids in the unambiguous category are presented. The presentation order is determined at least in part by a pre-specified economic utility function. When no match is detected then the associated advertisements for bids in the ambiguous category are presented. The presentation order is determined at least in part by an economic utility function and by analyzing the incremental input entered by the user in relation to the descriptive terms associated with advertisements for all bids in the ambiguous category to determine the relative relevance of the advertisements.

Another embodiment of the invention provides a user interface method where the preferences of the user are learned. The selection actions used by the user to select content items from the presented relevant subset of content items are analyzed along with the descriptive terms associated with the selected content items to determine and learn user preferences. The economic utility function considers the learned user preferences.

Another embodiment of the invention provides a user interface method where the context in which the user enters the incremental input is determined. The context includes at least one of the geographic location of the user, the date, the day, and time. The economic utility function considers the user context.

### BRIEF DESCRIPTION OF THE DRAWINGS

FIG. 1 illustrates a search system employing incremental search with minimal text entry.

FIG. 2 illustrates an advertisement system in accordance with one or more embodiments of the invention being used in a different range of device and network configurations.

FIG. 3 illustrates a user device configuration to perform incremental search and display of advertisements.

FIG. 4 illustrates the two states in which the user search session can be in the advertisement system presented in this invention.

FIG. 5 illustrates the state transition logic when starting from the Ambiguous state.

FIG. 6 illustrates the state transition login when starting from the Unambiguous state.

### DETAILED DESCRIPTION OF THE INVENTION

A method and system for supporting advertising in systems supporting incremental search is presented. The advertising can have either commercial value or informational value. In a system supporting incremental search, as the user continues entering text corresponding to the keyword to be searched, the currently entered text is compared with bids even before a whole word is entered. Advertisers can place bids for full words. In addition, advertisers can place bids for partial words, such as prefixes of whole words. For each incremental search, bids are evaluated and the bid that is expected to generate the maximum economic utility to the entity supplying the search service is considered the winning bid. The corresponding advertisement is served.

Embodiments of the present invention build on techniques, systems and methods disclosed in earlier filed applications, including but not limited to U.S. patent application Ser. No. 11/136,261, entitled Method and System For Performing Searches For Television Programming Using Reduced Text Input, filed on May 24, 2005, U.S. patent application Ser. No. 11/246,432, entitled Method And System For Incremental Search With Reduced Text Entry Where The Relevance Of Results Is A Dynamically Computed Function of User Input Search String Character Count, filed on Oct. 7, 2005, U.S. patent application Ser. No. 11/235,928, entitled Method and System For Processing Ambiguous, Multiterm Search Queries, filed on Sep. 27, 2005, U.S. patent application Ser. No. 11/509,909, entitled User Interface For Visual Cooperation Between Text Input And Display Device, filed Aug. 25, 2006, and U.S. patent application Ser. No. 11/682,693, entitled Methods and Systems For Selecting and Presenting Content Based On Learned Periodicity Of User Content Selection, filed on Mar. 6, 2007, the contents of which are hereby incorporated by reference. Those applications taught specific ways to perform incremental searches using ambiguous text input, methods of ordering the search results, and techniques for learning a user's behavior and preferences. Those techniques can be used with the sets of advertisements described herein in the same or similar ways in which the techniques are applied to the collections of content items described in those applications. In such a case, the advertisements described herein represent a particular type of content item. The present techniques, however, are not limited to systems and methods disclosed in the incorporated patent applications. Thus, while reference to such systems and applications may be helpful, it is not believed necessary to understand the present embodiments or inventions.

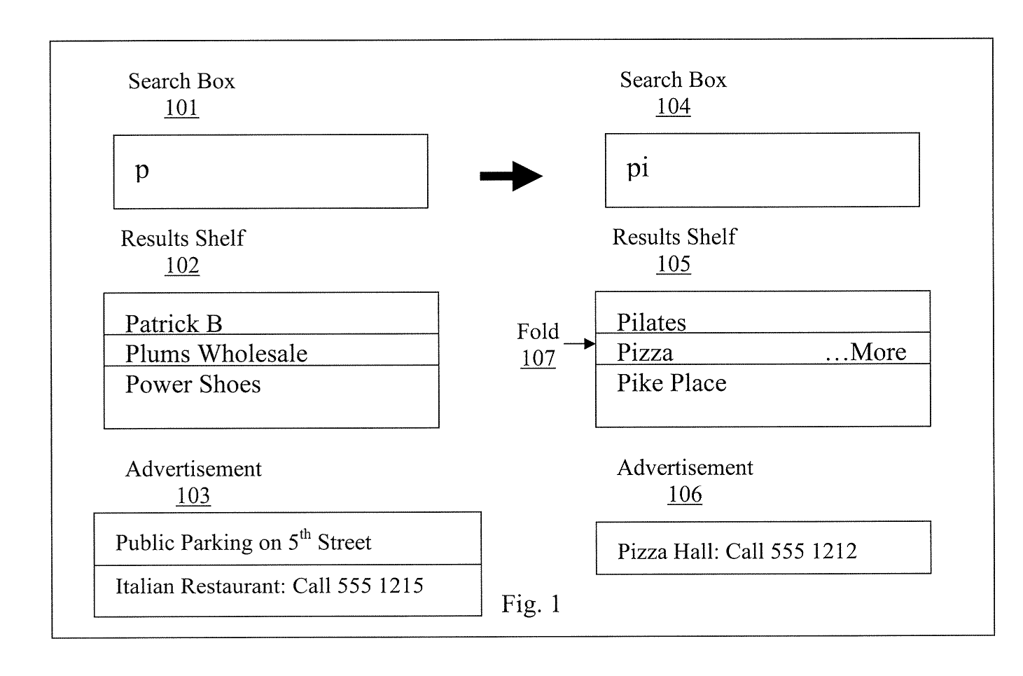

FIG. 1 illustrates one possible manifestation of incremental search. In systems incorporating incremental search with minimal text entry, text is entered in a dedicated Search Box 101. Results corresponding to the search are displayed in a Results Shelf 102 ordered according to some criteria of relevance. There are one or more dedicated spaces for Advertisements 103. The positioning of Advertisements 103 can be anywhere relative to the Results Shelf 102, such as adjacent, directly above, directly below, set-apart, etc. There can also be multiple slots for advertisements in the Advertisement space as illustrated in 103. Users can select an advertisement to trigger additional action such as seeing more information about the advertisement, view a video, call a phone number, etc.

With every incremental character entered in the Search Box, as seen in 104 compared to 101, a new search is conducted using the search string entered so far including the just-entered character and the results corresponding to the current string in the Search Box 104 are returned in the Results Shelf 105. Results in the Results Shelf 105 can also be a Fold 107, where the entry has a descriptive title (called a “label”) and stands for a collection of related items which can be accessed by selecting the Fold 107. Selecting a Fold is called “entering the Fold” or “descending the Fold”, while using any of the available navigation mechanisms to get out of the Fold and go back to the state before entering the Fold is called “exiting the Fold”. When the user has entered the Fold, he is said to be “within a Fold”.

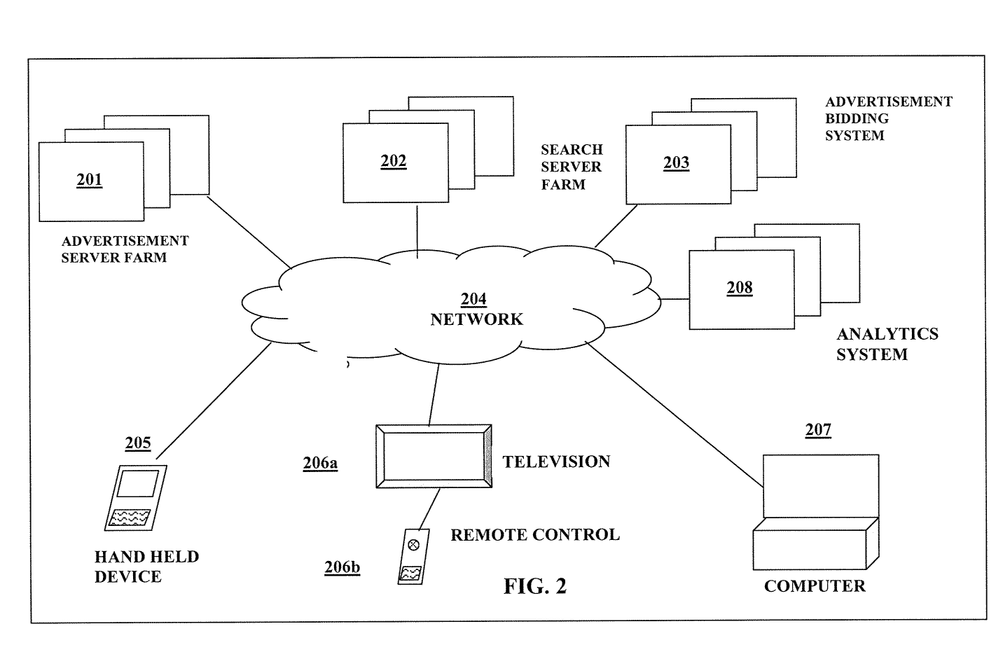

FIG. 2 illustrates an overall system for providing advertisements along with search results in systems supporting incremental searches using a wide range of devices in accordance with one or more embodiments of the invention. An Advertisement Server Farm 201 can serve as the source of advertisements to be served. A Search Server Farm 202 can serve as the source of search data and relevance updates with a network 204 functioning as the distribution framework.

A Network 204 serves as the distribution framework. The distribution framework can be a combination of wired and wireless connections. Examples of possible networks include cable television networks, satellite television networks, IP-based television networks, wireless CDMA and GSM networks. The search devices can have a wide range of interface capabilities such as a hand-held device 205 (e.g., a phone or PDA) with limited display size and a reduced keypad, a television 206a coupled with a remote control device 206b having a keypad, or a Personal Computer (PC) 207 with either a full keyboard or a reduced keyboard and a computer display.

An Advertisement Bidding System 203 enables advertisers to bid for advertisement slots. Advertisers or their agents place bids not only for full words, such as “pizza”, but also for partial prefixes of words, such as, in the case of pizza, “p”, “pi”, “piz”, or “pizz”. Likewise, systems and methods described in the incorporated U.S. patent application Ser. No. 11/235,928, entitled Method and System For Processing Ambiguous, Multiterm Search Queries and U.S. patent application Ser. No. 11/509,909, entitled User Interface For Visual Cooperation Between Text Input And Display Device, can be used with the techniques described herein. Those applications taught systems where codes can be entered for words, for example, when the number on the numeric key on which a given alphabet is printed in a telephone keypad are used to stand for the alphabet itself. When used with those types of systems, bids using numbers can be used to stand for the corresponding characters. For example, “7”, “74”, and “749” can be used to stand for “p”, “pi”, “piz” respectively when the input device is a telephone keypad. For each search, the bid that is evaluated to be the one that is expected to generate the maximum economic utility to the entity supplying the search service is considered the winning bid. The corresponding advertisement is served by the Ad Server system 201 for display to the user in Advertisement space 103. This will be described in more detail below.

This invention also provides for an Analytics System 208 that analyzes search user behavior and provides advertisers with information that can help the advertisers determine the partial words that they can bid for related to the items they intend to advertise. As discussed above, there can be multiple slots for advertisements in the Advertisement space 103. In such a case, the determination of which advertisement to display in the multiple slots is performed sequentially on a slot by slot basis in an order determined by the system.

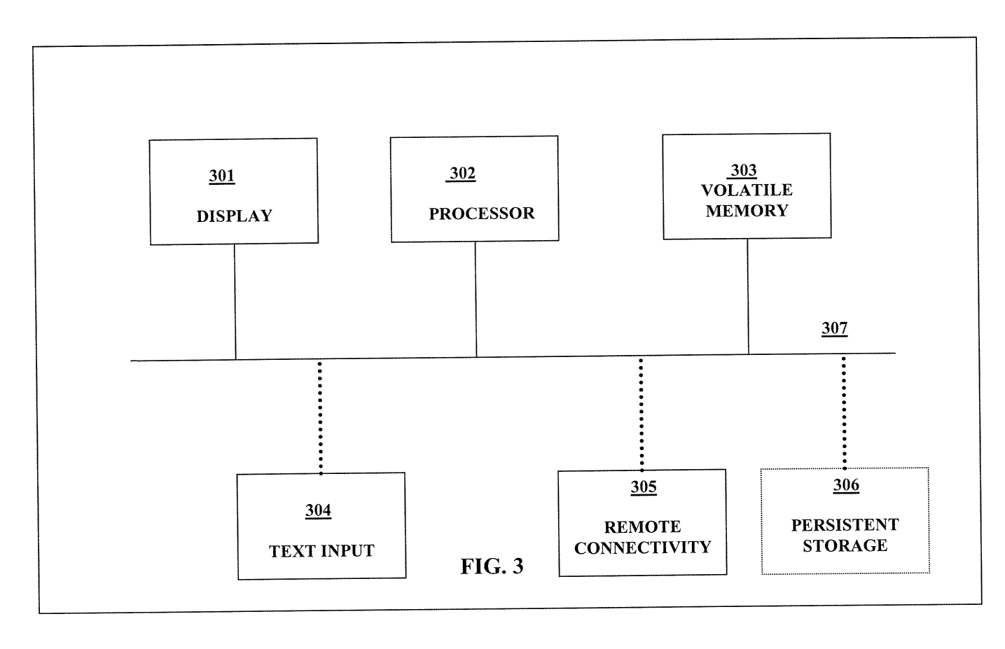

FIG. 3 illustrates multiple exemplary configurations for search devices in accordance with one or more embodiments of the invention. In one configuration, a search device such as the PC 207 can have a display 301, a processor 302, volatile memory 303, text input interface 304 (which can be on-device or through a wireless remote control 206b), remote connectivity 305 to the Search Server 202 through the network 204, and persistent storage 306. A configuration for a device such as the hand-held device 205 might not include local persistent storage 306. In this case, the hand-held device 205 can have remote connectivity 305 to submit the search query to, and retrieve the search results from, the Search Server 202. A configuration for a device such as the television 206a can include remote connectivity 305 and persistent storage 306. In this case, the device can use the remote connectivity 305 for search relevance data or for updates where the search database is distributed on the local persistent storage 306 and on the Search Server 202. The most suitable configuration for a memory constrained device is having the search data residing remotely on a server.

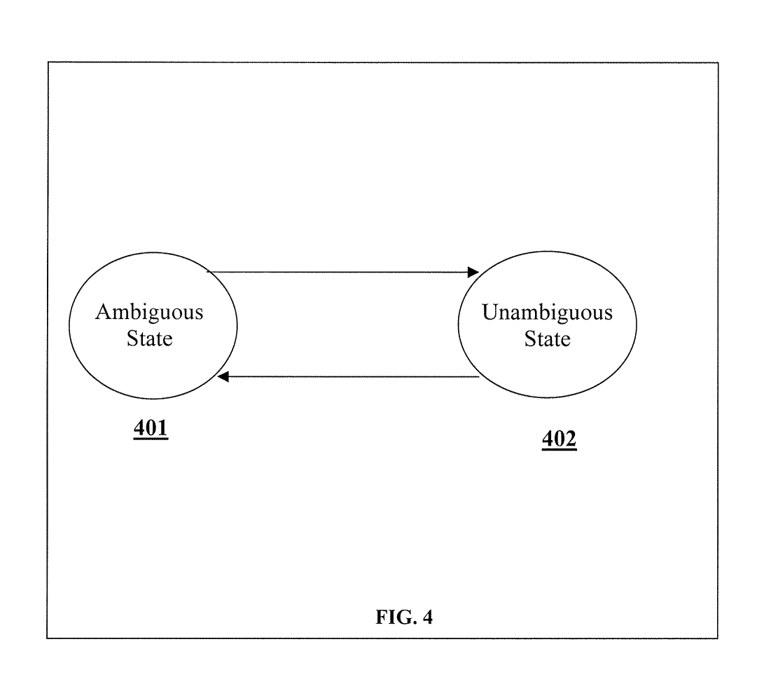

Referring to FIG. 4, depending on the search string entered, the state of the search session of the user in a search system implementing incremental search can be in one of two states: the Ambiguous state 401 or the Unambiguous state 402. The Advertisement Bidding System 203 allows the advertisers or their agents to place bids for advertisements in the Ambiguous state 401 and bids for advertisements in the Unambiguous state 402. As mentioned above, for each search, the bid that is evaluated to be the one that is expected to generate the maximum economic utility to the entity supplying the search service is considered the winning bid. The corresponding advertisement is served by the Ad Server system 201 for display to the user in Advertisement space 103.

The search session is in the Unambiguous state 402 if any one of the following conditions is satisfied: (1) the text in the Search Box 101 is a valid full word; (2) the text in the Search Box 101 is not a valid full word, that is, it is only a partial word, and there is a bid for that partial word in the Advertisement Bidding System 203; or (3) the user is within at least one Fold 107, as explained above, or has selected an item on the Results Shelf 102. The search session is in the Ambiguous state 401 if none of the conditions to be satisfied for being in the Unambiguous state 402 listed above are satisfied. In addition, when the user has not entered any text into the Search Box 101, the search session is in the Ambiguous state 401.

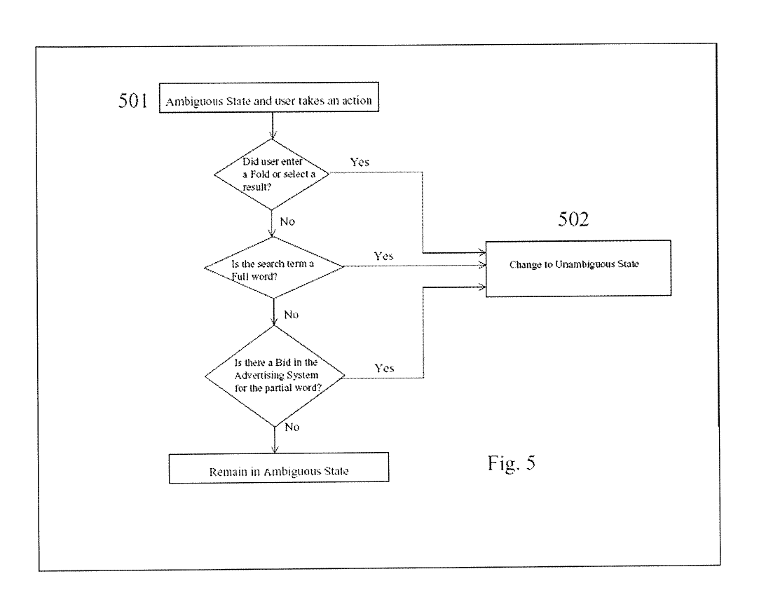

Referring to FIG. 5, when the search session is in the Ambiguous state 501 and the user takes an explicit action, such as selecting an entry in the Results Shelf 102 or entering a Fold 107, the state of the search session is moved to the Unambiguous state 502. For example, in the Results Shelf 105, if the user selects the Fold “Pizza . . . More” 107, then the search session is moved to Unambiguous state 502.

When the search session is in the Ambiguous state 501 and the user enters another character into the Search Box 101, a determination is made if the text currently in the Search Box 101, including the just entered character, is a valid full word. If the text in the Search Box 101 including the newly entered character is a full word, the state of the search session is moved to the Unambiguous state 502. For example, if the text currently in the Search Box 101 is “pizz” and the user enters the character “a”, the text in the Search Box 101 will become “pizza”, which is a valid word. Hence, the search session is moved to Unambiguous state 502. The rules determining what combination of characters constitute valid full words is dependent on the system implementing the search and can vary from system to system based on a variety of factors, including but not limited to the data domains on which the search is performed.

If, after a character is entered, the text in the Search Box 101 is not a valid full word but a partial word, the search session is retained in the Ambiguous state 401. However, if there is a bid in the Advertisement Bidding System 203 for that partial word, the state of the search session is moved to the Unambiguous state 502. For example, when there is no text currently in the text box and the user enters the character “p”, if there are no bids for “p” in the Advertisement Bidding System 203, the state is retained in Ambiguous state 501. However, if there is a bid for “p” in the Advertisement Bidding System 203, then the search session is moved to the Unambiguous state 502.

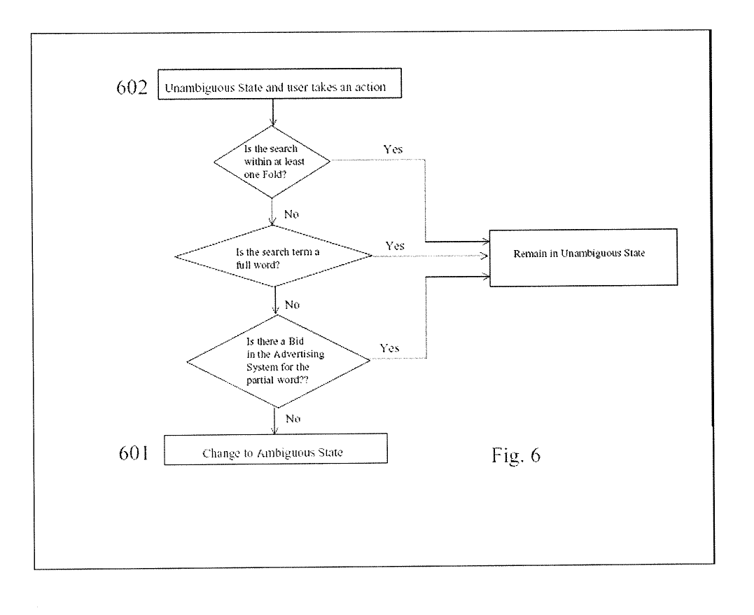

Referring to FIG. 6, when the search session is in the Unambiguous state 602 and the user is within at least one Fold, the search session is retained in the Unambiguous state 602 until the user exits all Folds. Upon the user exiting, the Search Box 101 is evaluated again, to see if the conditions for being in the Unambiguous state 601 are satisfied. If the conditions for being in Unambiguous state 602 continue to be satisfied, the search session is retained in the Unambiguous state 602, otherwise search session is moved to Ambiguous state 601. As an example, consider that the user is within the Fold “Pizza . . . More” 107, which he had selected after seeing the Results Shelf 105 after entering “pi” in the Search Box 104. When the user exits this fold, the text in the Search Box 104 will be “pi”. If there is no bid for “pi”, the search session will be moved to Ambiguous state 601.

If the search session is in the Unambiguous state 602, but not within any fold, and the user takes an action, such as deleting a character or enters one more character, then the text in the Search Box 101 is evaluated again, to see if the conditions for being in Unambiguous state 602 continue to be satisfied. If conditions for being in the Unambiguous state 602 are satisfied, the search session is retained in the Unambiguous state 602, otherwise it is moved to the Ambiguous state 401. As an example, if the current text in the Search Box 101 is “pizza”. This being a valid word, the search session is in the Unambiguous state 602. If the user deletes the “a” at the end, and the partial word “pizz” has no bid on it, the search session is moved to the Ambiguous state 601.

As noted above, competing bids are evaluated by the Advertisement Bidding System 203 and the bid that is expected to generate the maximum economic utility to the entity supplying the search service is considered the winning bid. A variety of criteria are used to determine which of the competing bids have the maximum expected economic utility to the entity supplying the search service. An example of such criteria could be based on the likelihood of the advertisement being acted upon by the individual user viewing the advertisement. For the Ambiguous state 401, this can involve factors including, but not limited to, the appearance of specific terms in the Results Shelf 105 and the relationship of the advertisement to those terms. For example, if the term “Pilates” appears on the Results Shelf 105 while in the Ambiguous state 401, then an advertisement related to Pilates may be deemed as likely to generate the maximum economic utility since the user is likely to call the advertiser and hence generate a fee for the entity providing the search.

Other factors that can be used to determine the winning bid are specific to the user of the search service at that point in time. This includes, but is not limited to, knowledge derived from the observed past behavior of the current user of the search. For example, while in the Ambiguous state 401, if the user is known to have lunch around the time the search is performed, then an advertisement for food may be determined to be the one that has a higher probability of being acted upon and therefore is expected to generate the maximum economic utility. Likewise, while in the Unambiguous state 402, if the user has entered “pi” in the Search Box 104, and advertisements for Pilates and Pizza are competing using identical bids for the partial keyword “pi”, and currently it is lunch time, the system can determine that there is a higher probability that the advertisement for Pizza is likely to be acted upon by the user (thereby generating higher economic value for the entity providing search when there is a price for the action) and hence may determine that the winning bid is the one for Pizza. Techniques disclosed in the applications incorporated above are useful in learning the user's behavior and preferences.

In one preferred embodiment of this invention, each advertisement bid has two components: one component for displaying the advertisement in the Advertisement space 103 (called an Impression) and a second component for actions performed by the user associated with the advertisement (called an Action). As an example, a pizza vendor could bid $1 for displaying “Pizza Hall: Call 555 1212” in the Advertisement space 103 and $0.50 for an action performed by the user on seeing the advertisement, such as clicking on the advertisement to call the number 555 1212. The action can be one of many other possibilities as well, such as for example, viewing a short video commercial or viewing the web site of the advertiser. In such an embodiment, the bid that is expected to generate the maximum economic utility is determined by taking into account the bids for the Impression, the probability that the user will perform the associated action, and the bids for the Action. The probability that the user will perform the associated action can be determined by taking into account a variety of factors, some of them generic factors (for example, related to the advertisement, actions of the some or all of the search users, etc.) and some other factors that take into account aspects related to the specific user of the search.

In one preferred embodiment of this invention the advertisement to be displayed to the user on an available advertisement slot in the Advertisement space 103 is determined based on which state the search session is in. The Advertisement Bidding System 203 allows the advertisers or their agents to place bids into two separate and distinct categories: bids for advertisement in the Ambiguous state 401 and bids for advertisement in the Unambiguous state 402. The Advertisement Bidding System 203 also allows bids for the Ambiguous state 401 to describe or specify the characteristics of the associated advertisement with the objective of enabling the system to determine the best advertisement to be displayed for a given available advertisement slot. Bids for the Unambiguous state 402 must also specify one or more texts associated with the bid. Such text can be not only full words, such as “pizza”, but also partial prefixes of words, such as, in the case of pizza, “p”, “pi”, “piz”, or “pizz”.

When the search session is in the Ambiguous state 401, all bids for the Ambiguous state 401 are evaluated. The bid that is evaluated to be the one that is expected to generate the maximum economic utility to the entity supplying the search service is considered the winning bid, and the corresponding advertisement is served by the Ad Server system 201 for display to the user in Advertisement space 103.

When the search session is in the Unambiguous state 402, all bids for the Unambiguous state 402 that have a perfect match of text corresponding to the bid with the words or partial words of text in the Search Box 101 as well as with the label(s) of the results or Fold(s) 107 are evaluated. Again, the bid that is evaluated to be the one that is expected to generate the maximum economic utility to the entity supplying the search service is considered the winning bid, and the corresponding advertisement is served by the Ad Server system 201 for display to the user in Advertisement space 103.

When the search session is in the Unambiguous state 402, but there are no bids available in the Advertisement Bidding system corresponding to any of the text entered in the Search Box 101 or the label(s) of results or Fold(s) 107 entered by the user, then the bids, if any, available for the Ambiguous state 401 are evaluated. For example, when the user is in the Unambiguous state 402 due to being in a Fold that is labeled as “Tom Cruise” and there are no bids for “Tom Cruise”, bids, if any, available for the Ambiguous state are evaluated and the bid that has the maximum expected economic utility to the entity supplying the search service is selected and displayed. In this case, if the search string was “br”, an advertisement for a DVD starring Brad Pitt may be determined to be the one that is expected to generate the maximum economic value because Tom Cruise and Brad Pitt are related to the overall concept of movies. Thus, there is a high likelihood of the user buying the DVD as the search session is in the Unambiguous state 402 due to being in a fold that is labeled as “Tom Cruise”, possibly indicating a desire to purchase a DVD, and the search string contains “br”, which is potentially a search for Brad Pitt. Techniques disclosed in U.S. Provisional Patent Application No. 60/825,616, entitled A Method Of Dynamically Generating Hierarchically Organized Result Clusters For An Incremental Search Query Matching One Or More Precomputed Hierarchical Clusters, filed Sep. 14, 2006, can be used with the techniques described herein. That application taught ways of generating search results based on combining concepts associated with incremental search results. Thus, those techniques can be used with the methods disclosed herein to determine which advertisements may be of interest the user by comparing concepts related to the search results and concepts related to the advertisements.

In one preferred embodiment of this invention, the Analytics System 208 provides information to advertisers on partial words entered by users in searches and the eventual selection of result items on the Results Shelf 102 in those searches. This can be used by advertisers to decide which partial words they can bid for in order to promote the items they intend to advertise. For example, if a large proportion of users who entered the partial word “pi” chose “Pizza”, then a pizza vendor would consider bidding for the partial word “pi”.

Having described preferred embodiments of the present invention, it should be apparent that modifications can be made without departing from the spirit and scope of the invention. For example, the term “advertisements” has been used herein to describe commercial offerings. However, as used herein, the term “advertisements” also represents any form of information supplied to the user.

What is claimed is:

1. A user-interface method of incrementally identifying and presenting a collection of content items and a collection of advertisements in which the identification is at least in part based on input incrementally entered by a user on an input-constrained device, the method comprising:
providing a set of content items, each content item having at least one associated descriptive term to describe the content item;
providing a set of bids and associated advertisements, each bid comprising at least one descriptive term to describe an associated advertisement; the bids being organized into at least an unambiguous category and an ambiguous category;
receiving incremental input entered on the input-constrained device by the user for identifying desired content items, the input having a set of user entry actions, each entry action having an associated set of at least one alphanumeric symbols, said input indicative of at least one prefix for a descriptive term the user is using to identify desired content;
in response to the incremental input entered by the user, identifying and presenting a relevant subset of the content items to the user;
in response to the incremental input entered by the use, determining, for each bid in the unambiguous category, whether the incremental input matches a descriptive term describing an associated advertisement;
if at least one match is detected, selecting and presenting the associated advertisements for all matching bids in the unambiguous category, in a presentation order determined at least in part by a pre-specified economic utility function; and
if no match is detected, selecting and presenting advertisements for all bids in the ambiguous category, in a presentation order determined at least in part by an economic utility function and by analyzing the incremental input entered by the user in relation to the descriptive terms associated with advertisements for all bids in the ambiguous category to determine the relative relevance of the advertisements.

2. A method of claim 1, wherein the selection of content and advertisements is additionally based on learned user preferences, the method further comprising:
receiving selection actions from the user to select content items from the presented relevant subset of content items;
analyzing the descriptive terms associated with the selected content items to determine learn user preferences, wherein the economic utility function considers the learned user preferences and raises the expected economic utility of bids associated with the learned user preferences.

3. The method of claim 1, wherein the selection of content and advertisements is additionally based on the user context within which the input was entered, the method further comprising:
determining a user context in which the user entered the incremental input, the user context including at least one of: geographic location of the user, date, day, and time;
wherein the economic utility function considers the user context and raises the expected economic utility of bids associated with the user context.
